(19) United States
(12) Patent Application Publication
(10) Pub. No.: US 2019/0037039 A1
(43) Pub. Date: Jan. 31, 2019

(54) PROCESSING SYSTEM CAPABLE OF PUSHING NOTIFICATIONS RELATED TO CORRESPONDING POSITIONS AUTOMATICALLY

(71) Applicant: NATIONAL CHIN-YI UNIVERSITY OF TECHNOLOGY, TAICHUNG (TW)

(72) Inventor: SHUNG-KUNG WU, TAICHUNG (TW)

(21) Appl. No.: 15/659,805

(22) Filed: Jul. 26, 2017

(51) Int. Cl. H04L 29/08; G06F 9/54

(52) U.S. Cl. CPC H04L 67/26; G06F 9/542; H04W 4/008; H04L 67/22; H04L 67/18

(57) ABSTRACT

A processing system capable of pushing notifications related to corresponding positions automatically includes an execution program, at least one locator, a data server, and a record server. The execution program includes a processing unit, a personal data identification unit having an identification data, a display unit compiled via at least one program language and displaying at least one pushing notification, and a determination unit positioning the locator. The determination unit includes execution kits for recognizing and positioning the locator to obtain a corresponding position data. The identification data and the position data are transmitted to the processing unit and thence to the data server. When the data match a preset condition stored in the data server, at least one specific push notification is sent to the display unit through the processing unit for displaying. Therefore, the function of combining positioning with the pushing of notifications is attained.

### BACKGROUND OF THE INVENTION

### 1. Field of the Invention

This invention relates to a processing system and relates particularly to a processing system capable of pushing notifications related to corresponding positions automatically.

### 2. Description of the Related Art

Generally, a user can surf the Internet through a browser to search required information, such as discount coupons, store information, merchandise information, route planning information and so on, after connecting a mobile Internet device to the network. However, the required information will not show on the browser actively. The user has to search on the Internet actively by entering keywords in order to obtain the information. Since the entered keywords may not be precise enough to retrieve the relevant information immediately, it increases the search difficulty. Even if the search results are accurate, not all of the results can be adopted at once. For example, terms and rule conditions of discount coupons may differ from each other in applied time period, applied store branches, or required qualifications. Thus, the user may not make use of the discount coupons successfully that ruins an original purpose of the discount coupons which is to expand the customer source. Hence, complaints and customer attrition are caused.

Moreover, usage state and browsing history of each user cannot be recorded and classified clearly when the user searches on the Internet. A conventional application compiled by JAVA program language is unable to obtain the browsing conditions of each user after broadcasting pushing notifications. Hence, the aforementioned deficiencies should be improved to allow the user to receive appropriate notifications concerning the current place where the user locates and record the browsing history after broadcasting pushing notifications.

### SUMMARY OF THE INVENTION

The object of this invention is to provide a processing system capable of pushing notifications related to corresponding positions automatically through searching and determining a position of surrounding locator actively.

The processing system capable of pushing notifications related to corresponding positions automatically of this invention includes an execution program installed in a mobile device, at least one locator connected to the execution program and continuing sending signals to define a signal area, a data server connected to the execution program and keeping at least one preset condition relative to the locator, and a record server connected to the execution program. The execution program has a processing unit, a personal data identification unit connected to the processing unit and keeping an identification data, a display unit connected to the processing unit to display at least one pushing notification, and a determination unit connected to the processing unit for positioning the locator. The display unit is compiled via at least one program languages including HTML5. Further, the determination unit has a plurality of execution kits connected to the processing unit. The execution kits are applied to search and interpret the locator to obtain a corresponding position data. The position data and the identification data are delivered to the data server for examining by the processing unit. When the position data and the identification data match the preset condition of the data server, the data server sends the specific pushing notification to the processing unit. The pushing notification is further sent to the display unit by the processing unit and showed on the display unit. Therefore, the mobile device can receive the specific pushing notification set beforehand after installing the processing system which takes advantages of the execution kits of the determination unit to determine the locator and the display unit to display the pushing notification. Thus, the user can obtain the relevant information based on the current location, thereby achieving the function of combining positioning with the pushing of notifications. Furthermore, the display unit is compiled with a syndetic code connected to the record server to save a browsing history of the display unit in the record server. Whereby the system programmer can study the browsing conditions of each user through the record server.

Preferably, the locator is a Bluetooth locator.

### BRIEF DESCRIPTION OF THE DRAWINGS

FIG. 1 is a schematic view showing a first preferred embodiment of this invention;

FIG. 2 is a block diagram showing the procedures of the data server;

FIG. 3 is a block diagram showing the procedures of the display unit; and

FIG. 4 is a block diagram showing the procedures of the processing system.

### DETAILED DESCRIPTION OF THE PREFERRED EMBODIMENTS

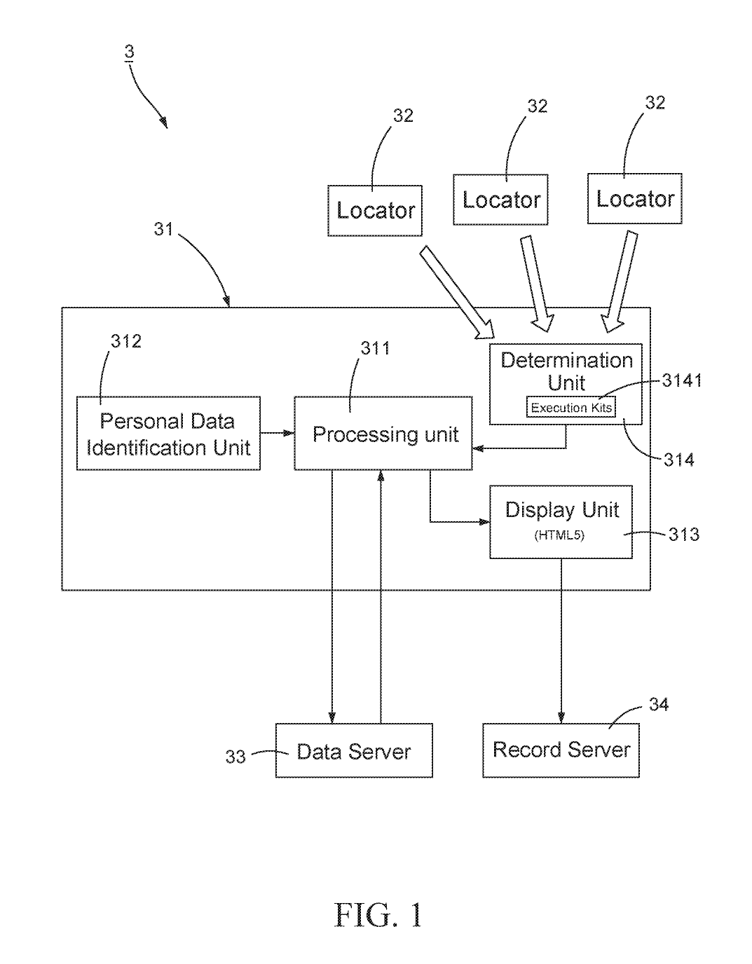

Referring to FIG. 1, a first preferred embodiment of a processing system capable of pushing notifications related to corresponding positions automatically 3 of this invention includes an execution program 31 installed in a mobile device (not shown), at least one locator 32 connected to the execution program 31, a data server 33 connected to the execution program 31 and saving at least one preset condition correlative to the locator 32 and pushing notification, and a record server 34 connected to the execution program 31. The locator 32 is capable of emitting signals continuously to forma signal area which allows the execution program 31 to capture and detect, thereby orientating a position of the locator 32. Further, each locator 32 has a unique recognition code. In this embodiment, it is taken as an example that the locator 32 is a Bluetooth low energy locator, such as iBeacon device. Meanwhile, the execution program 31 includes a processing unit 311, a personal data identification unit 312 connected to the processing unit 311 and saving an identification data, a display unit 313 connected to the processing unit 311 to present the pushing notification, and a determination unit 314 connected to the processing unit 311 for ascertaining the recognition code of the locator 32.

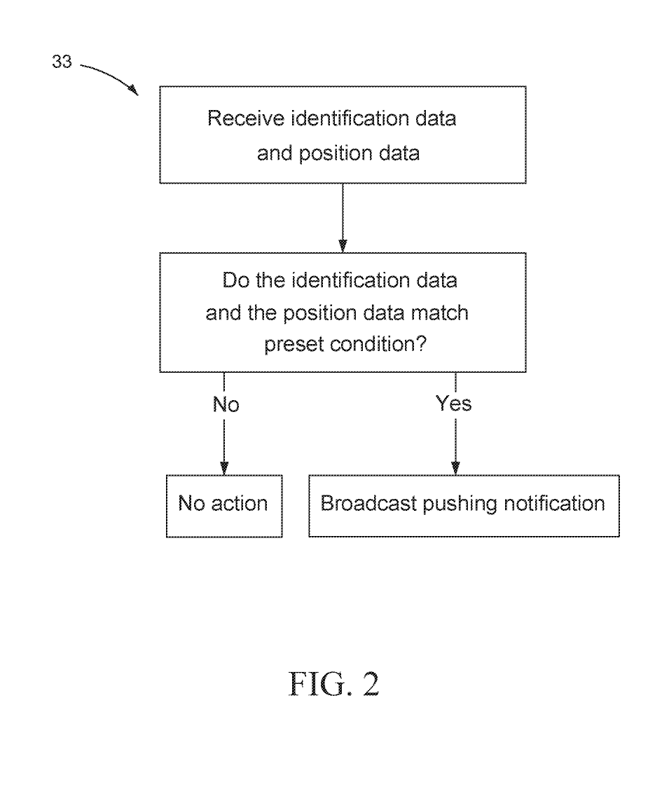

The determination unit 314 has a plurality of execution kits 3141 connected to the processing unit 311. Here takes an example that the execution kits 3141 include a location manager, an iBeacon service notifier, a location manager command, and a pausable thread pool executor in this preferred embodiment. When the user enters the signal area of the locator 32, the location manager detects the position of the locator 32 based on the signals in the signal area. Then, the location manager command determines and identifies the recognition code of the locator 32 to obtain a position data matching the location of the locator 32. The pausable thread pool executor further transmits the position data to the processing unit 311. Therefore, the execution kits 3141 are capable of obtaining the position data after searching the surrounding locator 32, determining the position of the locator 32 and interpreting the recognition code of the locator 32. The processing unit 311 further transmits the position data and the identification data to the data server 33 for matching the position data and the identification data with the preset condition of the data server 33. The preset condition which influences whether the user receives the pushing notification can be set based on requirements. For instance, the preset condition can be adjusted to differentiate each user according to member grade, browsing habit, member consumption and so on. Referring to FIG. 2, the data server 33 determines whether the position data and the identification data fit the preset condition after receiving the position data and the identification date. If the position data and the identification data match the preset condition, the data server 33 broadcasts the exclusive pushing notification, such as discount coupons, planning routes, or advertisements, to the processing unit 311. On the contrary, no action will be taken if the position data and the identification data unfit the preset condition. Afterward the processing unit 311 transmits the pushing notification to the display unit 313. Hence, the user can see the pushing notification through the display unit 313, thereby achieving the effect of broadcasting the pushing notification for personal use automatically and speedily.

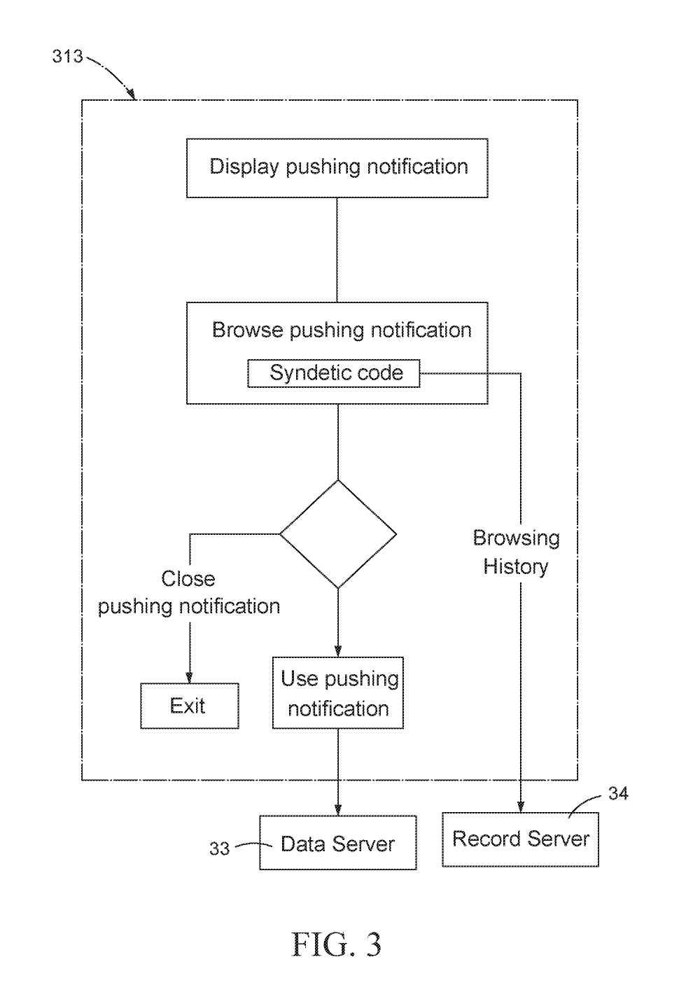

Referring to FIG. 3, the display unit 313 is compiled via at least one program language including HTML5 program language to receive and present the pushing notification through a web page. In addition, the display unit 313 compiles a syndetic code connected to the record server 34. Therefore, a browsing history of the display unit 313 can be saved in the record server 34. Meanwhile, the usage condition of the pushing notification is recorded in the data server 33 when the user clicks and uses the pushing notification. On the contrary, no action will be taken if the user close the pushing notification directly. When compiling the display unit 313 via HTML5 program language, the tool “Google Analytics” can be adopted as the record server 34 directly to connect the display unit 313 with the “Google Analytics”. Hence, the record server 34 can assist in gathering statics, recording the browsing history and usage state of the pushing notification to be used by the programmer.

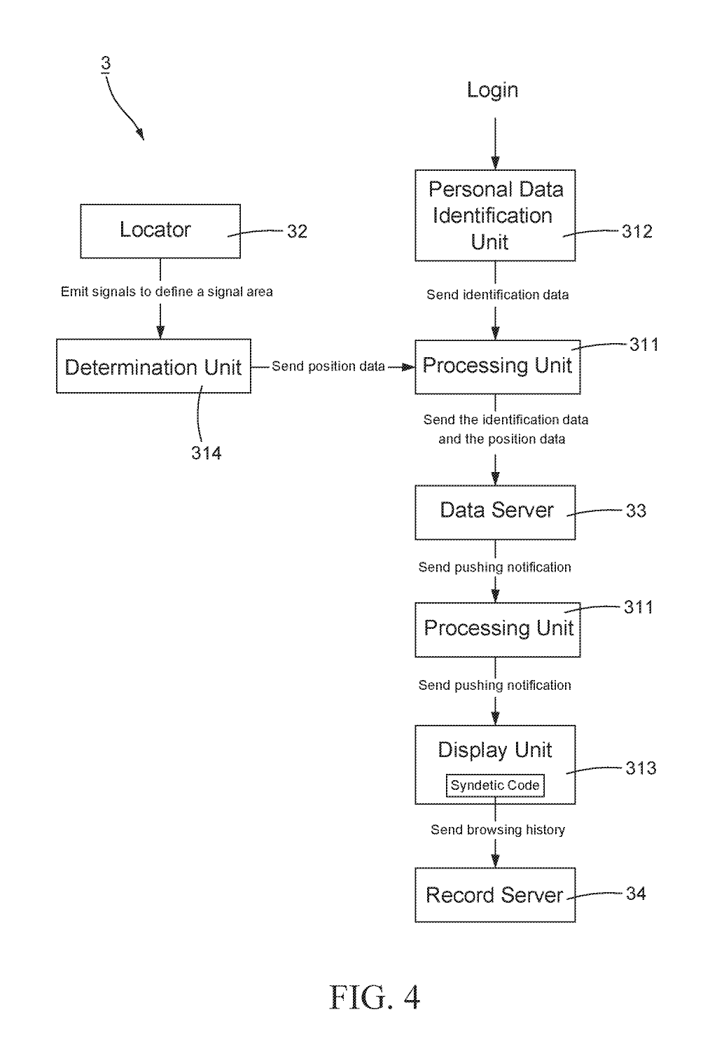

Referring to FIG. 1 and FIG. 4, in order to use the processing system 3, the user installs the execution program 31 in the mobile device first. After entering the execution system 31, the user registers the membership and keys in the personal information in the personal data identification unit 312 to generate the identification data. The identification data is then delivered to the processing unit 311 by the personal data identification unit 312. Further, the locator 32 is placed in stores. Several locators 32 can be applied and located according to different display cases or display goods in the same store. In addition, the preset pushing notifications relevant to each store are stored in the data server 33. When the mobile device carried by the user locates in the signal area of the locator 32, the determination unit 314 positions the locator 32 automatically and recognizes the recognition code of the locator 32 to obtain the position data. The position date is then delivered to the processing unit 311. The processing unit 311 further sends the position data and the identification data to the data server 33. The data server 33 matches the position data and the identification data with the preset condition to send the specific pushing notification to the processing unit 311 when the position data and the identification data fit the preset condition. The processing unit 311 further delivers the pushing notification to the display unit 313 to allow the user to catch the useful information or receive the available discount coupons via the display unit 313. Therefore, the user can receives the usable pushing notification automatically when approaching the locator 32 in the store. Whereby the pushing notifications are broadcasted quickly and precisely and the unnecessary information is reduced effectively. Moreover, the syndetic code can be compiled directly in the display unit 313, thereby recording the browsing history during the displayed period of the pushing notifications in the record server 34. The browsing history can be further analyzed for use in following tracking and broadcasting adjustment.

To sum up, the processing system capable of pushing notifications related to corresponding positions automatically of this invention takes advantages that the execution program has the processing unit, the personal data identification unit storing the identification data, the display unit compiled via HTML5 program language to present the pushing notification, and the determination unit recognizing the locator and having the execution kits connected to the processing unit. Hence, the execution kits position the locator and determine the recognition code of the locator to obtain the position data. The position data and the identification data are then delivered to the data server. When the position data and identification data fit the preset condition of the data server, the data server further sends the pushing notification to the processing unit to show the pushing notification on the display unit. Whereby the function of combining positioning with the pushing of notifications is attained.

While the embodiments of this invention are shown and described, it is understood that further variations and modifications may be made without departing from the scope of this invention.

What is claimed is:

1. A processing system capable of pushing notifications related to corresponding positions automatically comprising an execution program installed in a mobile device, at least one locator connected to said execution program, a data server connected to said execution program and storing at least one preset condition relevant to said at least one locator, and a record server connected to said execution program, wherein said at least one locator emitting signals continuously to define a signal area capable of being detected and captured by said execution program, thereby allowing a location of said at least one locator to be positioned by the execution program, each of said at least one locator having a recognition code, said execution program including a processing unit, a personal data identification unit connected to said processing unit and storing an identification data, a display unit connected to said processing unit to show at least one push notification, and a determination unit connected to said processing unit for interpreting and determining said recognition code of said at least one locator, said display unit being compiled by at least one program language which includes HTML5 program language to present said at least one push notification through a web page, said determination unit having a plurality of execution kits connected to said processing unit, said plurality of execution kits being adapted to search said at least one locator and obtain a position data corresponding to the location of said at least one locator by recognizing said recognition code of said at least one locator, said processing unit sending said position data and said identification data to said data server concurrently, said data server broadcasting said at least one push notification which is specific for personal use to said processing unit when said position data and said identification data match the preset condition of said data server, said pushing notifications being sent to said display unit by said processing unit and displayed on said display unit, said display unit compiling a syndetic code connected to said record server to store a browsing history in said record server.

2. The processing system as claimed in claim 1, wherein said at least one locator is a Bluetooth locator.
